(19) United States
(12) Patent Application Publication
(10) Pub. No.: US 2012/0096466 A1
(43) Pub. Date: Apr. 19, 2012

(54) METHOD, SYSTEM AND PROGRAM FOR DEADLINE CONSTRAINED TASK ADMISSION CONTROL AND SCHEDULING USING GENETIC APPROACH

(76) Inventor: Wei Sun, Tokyo (JP)

(21) Appl. No.: 13/144,822

(22) PCT Filed: Feb. 5, 2010
(86) PCT No.: PCT/JP2009/052355

§ 371 Date: Jul. 15, 2011

(51) Int. Cl. G06F 9/46

(52) U.S. Cl. 718/102

(57) ABSTRACT

Disclosed is an admission control and scheduling method of deadline constrained tasks. The method comprises: buffering new arriving tasks into a waiting queue; pre-scheduling a new task and a previously admitted task; producing multiple pre-schedules; using the most feasible pre-schedule as an executive schedule; and dispatching the tasks in the executive schedule.

This application is the National Phase of PCT/JP2009/052355, filed Feb. 5, 2009.

### TECHNICAL FIELD

The invention relates to resource management software design in computer and communication systems and, more specifically, to developing admission and scheduling software for deadline constrained task running in a set of given resources.

### BACKGROUND

Deadline constrained task scheduling is known broadly as real-time task scheduling. The fundamental multiprocessor scheduling problems often considered in computer and communication systems contains two instances:

on-line scheduling of sequential tasks in real-time environment, where all tasks must be completed by their deadlines, and

on-line scheduling of sequential tasks to minimize average response time.

This invention belongs to the first class. In [1], the theoretical analysis has shown that there is no optimal algorithm existing to schedule all feasible inputs of the hard-real-time scheduling problem when the number of resources is more than 2. EDF (Earliest Deadline First) has been proved to be the optimum in single processor real-time scheduling in [2]. But in multiprocessor system the optimality of EDF scheduling breaks down [3].

Admission control can be found in almost all the places where QoS (Quality of Service) is a key factor. The basic function of admission control is to judge whether a system has enough resources available to accept a new resource request, and then either accepts or rejects the request. In ATM networks, admission control is known as Connection Admission Control. In wireless network, for example IEEE 802.11, it is known as Call Admission Control. In computer systems, for example Clusters and real-time multiprocessor, task/job admission control helps QoS guarantee especially in Service Oriented Architecture. Exemplary of related literatures are [4, 5, 6, 7, 8].

Using a genetic algorithm (GA) in resource allocation has been shown to hold an advantage over the traditional algorithms in [9, 10]. But the long execution time is a defect of GA shown in admission control [4, 10]. Therefore, GA is tried to be accelerated when GA is used in solving the practical problems as in [11].

### [Non-Patent Document 1]

Cynthia Phillips, Cliff Stein, Eric Torng and Joel Wein, “Optimal Time-Critical Scheduling Via Resource Augmentation”, ACM Symposium on Theory of Computing, 1997, pages 0-34.

### [Non-Patent Document 2]

C. L. Liu and James W. layland, “Scheduling Algorithm for Multiprogramming in a Hard-Real-Time Environment”, Journal of the ACM, 1973, pages 46-61.
[Non-Patent Document 3]

J. W. S. Liu, Real-Time Systems, Prentice-Hall, 2000, pages 66-71.

### [Non-Patent Document 4]

Maninak Chatterjee, Haitao Lin and Sajal K. Das, “Rate Allocation and Admission Control for Differentiated Services in CDMA Data Networks”, IEEE Transactions on Mobile Computing, 2007, pages 179-191.

### [Non-Patent Document 5]

“Method and Apparatus for Admission Control and Radio Resource Scheduling in Wireless Systems, Corresponding System and Computer Program Product”, World Intellectual Property Organization, International Publication Number WO 2008/058887 A1, 2008.

### [Non-Patent Document 6]

“Method and System for Determining Optimum Resource Allocation in a Network”, United States Patent Application Publication, Pub No.: US 2006/0253464, 2006.

### [Non-Patent Document 7]

D. E. Irwin, L. E. Grit and J. S. Chase, “Balancing Risk and Reward in a Market-based Task Service”, 13^{th} International Symposium on High Performance Distributed Computing, 2004, pages 160-169.

### [Non-Patent Document 8]

F. I. Popovici and J. Wilkes, “Profitable Services in an Uncertain World”, 18^{th} Conference on Supercomputing, 2005.

### [Non-Patent Document 9]

A. Y. Zomaya and Y. H. Teh, “Observations on Using Genetic Algorithms for Dynamic Load-balancing”, IEEE Transactions on Parallel and Distributed Systems, 2001, pages 899-911.

### [Non-Patent Document 10]

T. D. Braun, H. J. Siegel, N. Beck, et. al., “A Comparison of Eleven Static Heuristics for Mapping a Class of Independent Tasks onto Heterogeneous Distributed Computing Systems”, Journal of Parallel and Distributed Computing, 2001, pages 810-837.

### [Non-Patent Document 11]

S. Song, K. Hwang and Y. K. Kwok, “Risk-Resilient Heuristics and Genetic Algorithms for Security-Assured Grid Job Scheduling”, IEEE Transactions on Computers, 2006, pages 703-719.

### SUMMARY

The entire disclosures of the above mentioned Patent Document and Non-Patent Documents are herein incorporated by reference thereto. The analysis below described is given by the present invention.

First of all, the detailed programming model and the notations are introduced as follows.
(1) Multiple resources service multiple tasks. A resource can be a processor, computer, or a channel in communication system and so on. In order to keep the consistence in this document, a resource is denoted as a node, The total number of nodes is N. A task can be a process and a thread in computer programming or a call and connection request in communication systems. Since tasks have many instances in different applications and systems, in this invention a task is defined to be a resource request which occupies exclusively a resource (a node) for a period of time.
(2) A task Tᵢ arrives with deadline dᵢ. To be general, the service time of a task in a node is usually different from that in another node. Hence, the service time of a task Tᵢ in the whole system is a vector {s_{i, 1}, s_{i, 2}, . . . s_{i, N}}. When all s_{i, j} of a task are identical, the programming model refers to homogeneous systems. When they are different, the programming model refers to heterogeneous systems.
(3) The admission and scheduling system, the scheduler, in this invention is shortly called ASS, whose architecture is shown in FIG. 1.
(4) When a task arrives, ASS should make a decision whether the new task is accepted or rejected. This is the task admission. When the finish time of a task is earlier than its deadline, the task is said to meet its deadline, and on the contrary the task misses its deadline. A task is accepted only if the task can meet its deadline, no matter which node the task will be allocated, or the task should be rejected. Meanwhile, no previously admitted tasks will miss their deadlines due to the admission of the new task. Hence, when ASS decides to accept a new task, a feasible schedule must be created at the same time. This is the task scheduling.
(5) in denotes the number of tasks including the previously admitted tasks and a new arriving task which are dealt with by ASS in admitting the new task and creating the feasible schedules.

There is a need in the art to provide an admission control and scheduling method and its corresponding system which can accept more tasks in a short admission time. To be simple, there is a need to provide a good trade off between high acceptance ratio and short admission time.

In one (first) aspect of the present invention, there is provided an admission control and scheduling method of deadline constrained tasks including: buffering a new arriving task into a waiting queue; pre-scheduling the new task and a previously admitted task; producing multiple pre-schedules; using the most feasible pre-schedule as an executive schedule; and dispatching the tasks in the executive schedule.

In another (second) aspect of the present invention, there is provided an admission control and scheduling system including: a task buffer that buffers a new arriving task into a waiting queue; a pre-scheduling module that pre-schedules the new arriving task and a previously admitted task, produces multiple pre-schedules and uses the most feasible pre-schedule as an executive schedule; a first storage that stores the pre-schedules; a second storage that stores the executive schedule; and a task dispatcher that dispatches the tasks in the executive schedule.

In a further (third) aspect, there is provided an admission control and scheduling program which causes to execute the method or system according to the aspect aforementioned. The program may be recorded on a non-transitory computer-readable recording medium.

Specifically the program comprises the processings: buffering a new arriving task into a waiting queue; pre-scheduling the new task and a previously admitted task; producing a plurality of pre-schedules; using the most feasible pre-schedule as an executive schedule; and dispatching the tasks in the executive schedule.

The present invention provides the following advantage, but not restricted thereto. Meritorious effect of the present invention is that more tasks can be accepted in a short admission time, namely, a good trade off between high acceptance ratio and short admission time is obtained.

### BRIEF DESCRIPTION OF THE DRAWINGS

FIG. 1 is a diagram illustrating architecture of an admission and scheduling system (ASS) according to the present invention.

FIG. 2 is a diagram illustrating the flowchart of a genetic algorithm (GA) according to the present invention.

FIG. 3 is a diagram illustrating a chromosome in GA according to the present invention.

FIG. 4 is a diagram illustrating mechanism of the slide mutation in GA according to the present invention.

FIG. 5 is a diagram illustrating an instance that facilitates the understanding of shrinking and expanding chromosomes.

FIG. 6 is a diagram illustrating a process where chromosome length and the population size can be changed dynamically.

FIG. 7 is a block diagram illustrating a structure of an admission control and scheduling system according to the present invention.

### PREFERRED MODES

In a fourth aspect of the present invention, there is provided a method, wherein said pre-scheduling comprises:

backuping the population;

expanding chromosomes in the population with the new task;

searching the optimum solution using a genetic algorithm;

accepting the new task and using the most feasible schedule to replace the executive schedule if the new task can be admitted; and

rejecting the new task and rolling the population back to the backup population if the new task cannot be admitted.

In a fifth aspect of the present invention, there is provided a method, wherein said expanding chromosomes is to attach a new gene which is the new task randomly assigned to a node.

In a sixth aspect of the present invention, there is provided a method, wherein the genetic algorithm comprises:

evaluating each individual and calculating a fitness value and an unfitness value;

selection;

crossover;

slide mutation;

coordination;

replacement;

updating population size; and

stop condition.

In a seventh aspect of the present invention, there is provided a method, wherein said fitness value is the total time cost of all tasks and said unfitness value is the total obliged time of the tasks missing their deadlines.

In a eighth aspect of the present invention, there is provided a method, wherein said time cost is the time that a task occupies a node exclusively and said obliged time is the time that the deadline of a task missing its deadline subtracts the current time when the admission is underlying.

In a ninth aspect of the present invention, there is provided a method, wherein said selection in the presence is a binary tournament which randomly selects two individuals from the population and then use the better one as a parent.

In a tenth aspect of the present invention, there is provided a method, wherein said selection has some alternatives often used in other genetic algorithms.

In a eleventh aspect of the present invention, there is provided a method, wherein said crossover in the presence is a single-point crossover which randomly selects a point p, and then two parents exchange former p genes and latter (n-p) genes with each other.

In a twelfth aspect of the present invention, there is provided a method, wherein said slide mutation is to move an obliged task from a heavily loaded node to a lightly loaded node.

In a thirteenth aspect of the present invention, there is provided a method, wherein said coordination is to sort tasks in each node by non-decreasing lead-time sequence.

In a fourteenth aspect of the present invention, there is provided a method, wherein said lead-time means the absolute difference between the deadline of a task and the current time.

In a fifteenth aspect of the present invention, there is provided a method, wherein said replacement comprises:

replacing an old individual with the new individual created after said crossover if its unfitness value is less than that of the former;

replacing the old individual with the smallest fitness value if all the unfitness values of the old individuals are 0;

preventing the new individual to enter the population if the new individual has the same chromosome structure with one of the old individuals in the population, and

invoking updating population size by the replacement.

In a sixteenth aspect of the present invention, there is provided a method, wherein said updating population size is to expand and shrink the population size in a way that the population is shrunk if the population size is larger than one third of the length of chromosomes, and otherwise the population is expanded so that the replacement will not replace any individual and add the new child individual into the population directly.

In a seventeenth aspect of the present invention, there is provided a method, wherein said stop condition including two parameters, an evolution limit and a maximum time limit, and the iteration of GA stops if any one of the parameters reaches a predetermined value.

In a eighteenth aspect of the present invention, there is provided a method, wherein the evolution limit is a maximum number of iterations when no new individual has been generated to improve the best solution, and the maximum time limit is a maximum number of iterations of GA.

In a nineteenth aspect of the present invention, there is provided a system, wherein

a task submitted by a user waits in the waiting queue and is served in the way of First Come First Serve (FCFS);

the pre-scheduling module schedules the waiting tasks one by one;

when the pre-scheduling module serves the new task, the new task and the previously admitted task are scheduled together, that is, the previously admitted task is rescheduled;

the pre-scheduling module outputs a plurality of feasible schedules, named pre-schedules;

the pre-scheduling module selects the most feasible pre-schedule according to a system requirement;

the selected pre-schedule is used as a new executive schedule; and the tasks in the executive schedule are dispatched only if there is no waiting task on the corresponding node;

a record of a task will be deleted from the executive schedule after the task is dispatched; and

the executive schedule is changed dynamically as a new task being admitted and an old task being dispatched.

In a twentieth aspect of the present invention, there is provided a system, wherein the system requirement is the most balanced load.

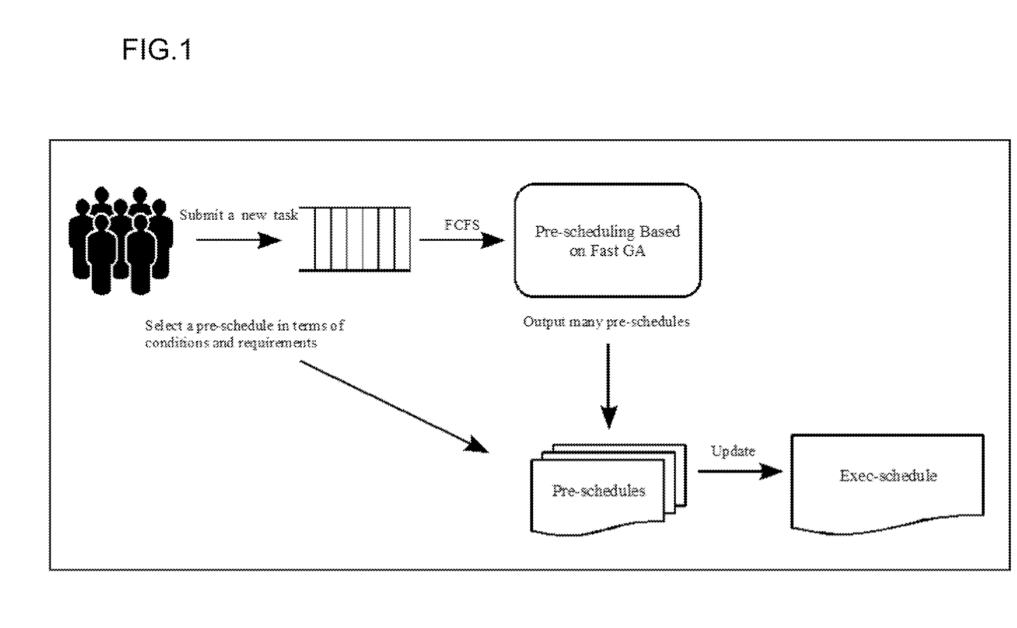

The architecture of ASS has been shown in FIG. 1. All the tasks submitted by users wait in the waiting queue and are served in the way of First Come First Serve (FCFS). The pre-scheduling schedules the waiting tasks one by one. When the pre-scheduling serves a new task, this new task and all the previously admitted tasks are scheduled together, that is the previous tasks will be rescheduled. It is possible that the pre-scheduling will output multiple feasible schedules, named pre-schedules, which can guarantee the deadlines of the previously admitted tasks and the new one. The most feasible pre-schedule will be selected according to the system requirements for example the minimum time cost of all tasks. The selected pre-schedule will be used as a new exec-schedule (executive schedule). The tasks in exec-schedule are dispatched only if there is no waiting task on the corresponding node. After a task is dispatched, the record of this task will be deleted from the executive schedule. The executive schedule is changed dynamically as a new task being admitted and an old task being dispatched. If there is no new task coming for a long time, the executive schedule could become empty. The time used by this admission and scheduling process must be so small to reduce the task waiting time in the waiting queue. Thus, the pre-scheduling should output many possible pre-schedules as the candidates in a short time.

Obviously, the new method of pre-scheduling is the core of the invention. Either high task acceptance ratio or short admission time depends on the pre-scheduling. Moreover, the other benefit of ASS, which is important in SOA, is to offer users the choices on their task executions. This benefit also depends on the pre-scheduling. A genetic algorithm is used to realize pre-scheduling. In this GA the population contains many solutions and the previously generated population can be re-used to speed up the GA.

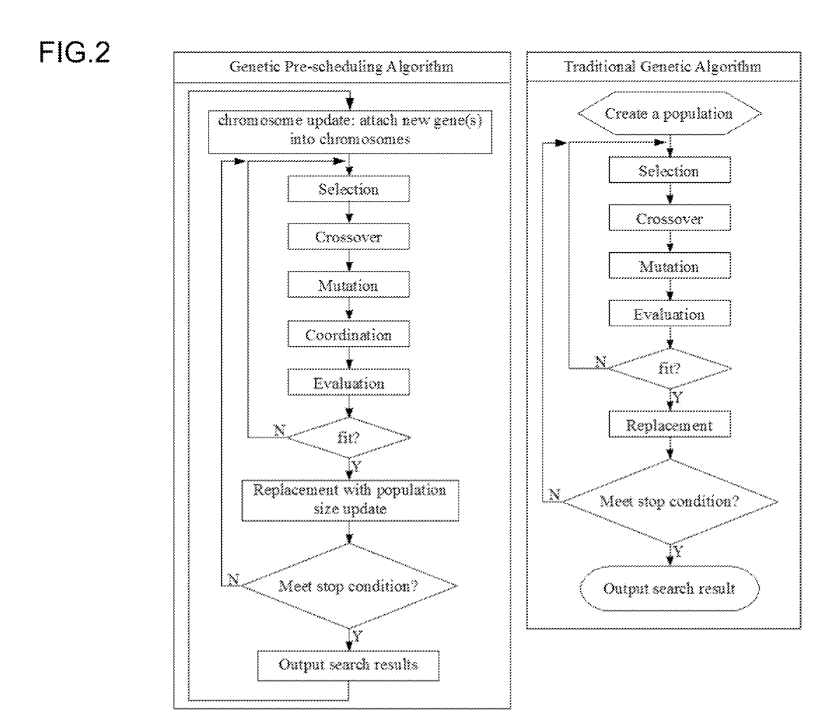

A genetic algorithm is a biologically inspired search method, which partially searches for a large solution space, known as population, and uses historical information to exploit the best solution from previous searches, known as generations, along with random mutations to explore new regions of the solution space. A solution is also known as an individual of the population. Hereinafter, the terms (solution and individual) are exchangeable. The flowchart of both the common GA and the GA of this pre-scheduling is shown in FIG. 2. The detailed setting and mechanisms of the GA of this pre-scheduling are listed in the below.

### <Encoding and Population Size>

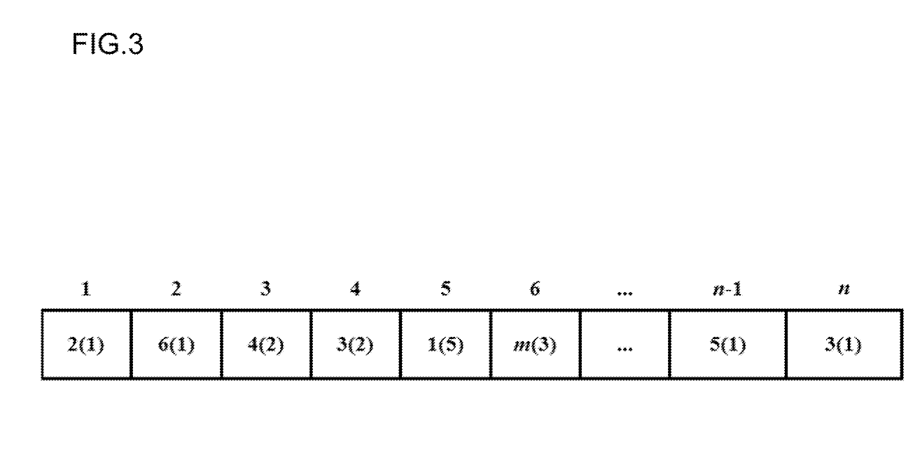

The encoding represents a chromosome of individual, which can be transformed into pre-schedule. A number in the chromosome is a gene, which represents the task to be allocated to the node denoted by this number. A chromosome is illustrated in FIG. 3. A sub-gene is the sequence of a task in a node. For instance, 3(2) means the 4^{th} task is on the 3^{rd} node and its execution sequence is the second. The selection, mutation and crossover operations are performed on the genes. The sub-genes are tuned by the coordination.

A new task will be attached at the tails of all chromosomes in the population. If an old task is dispatched to a node, the corresponding gene will be deleted from all chromosomes. The convergence time and the quality of result in a genetic algorithm are sensitive to the population size. The larger population, the better the quality of result is, and the longer the convergence time is. In order to shorten the convergence time, the population size is changed as the number of tasks, i.e., the chromosome length. The minimum size of the population is always identical to the number of nodes and the maximum size is less than or equal to one third of the length of chromosomes. Hence, the population size is

$${Size}_{population} = max ( N , ⌈ \frac{m}{3} ⌉ ) . \qquad ( 1 )$$

### <Fitness and Unfitness Values>

A fitness value and an unfitness value are used to evaluate the quality of individuals. The fitness value f is used to evaluate the total time cost of all m tasks. The fitness function is defined to be

$$f = {\sum }_{i = 1}^{m} ( {s}_{i , j} \vert {T}_{i} ↦ {n}_{j} ) . \qquad ( 2 )$$

Here, [symbol] denotes task Tᵢ is in node nⱼ. The unfitness value μ measures the total delay time of all m tasks. The unfitness function is defined to be

$$μ = {\sum }_{i = 1}^{m} [ \frac{min ( 0 , {d}_{i} - {s}_{ij} - {t}_{s} )}{{d}_{i} - {t}_{s}} \vert {T}_{i} ↦ {n}_{j} ] . \qquad ( 3 )$$

tₛ is the time point when the new task is pre-scheduled.

Thus, the fitness value is always non-negative and the unfitness value is always non-positive.

### <Selection and Crossover>

The selection is two binary tournaments. In a tournament, two individuals are picked out randomly from the population. The more feasible one will be chosen as one parent. Two tournaments will select two parents.

The two selected parents will produce a new individual in the crossover. The simple one point crossover may be used. A crossover point p is chosen randomly. Two parents exchange the former p genes and the latter (n-p) genes with each other. After the crossover, a new individual is produced. The crossover has some alternatives often used in other genetic algorithms.

### <Mutation>

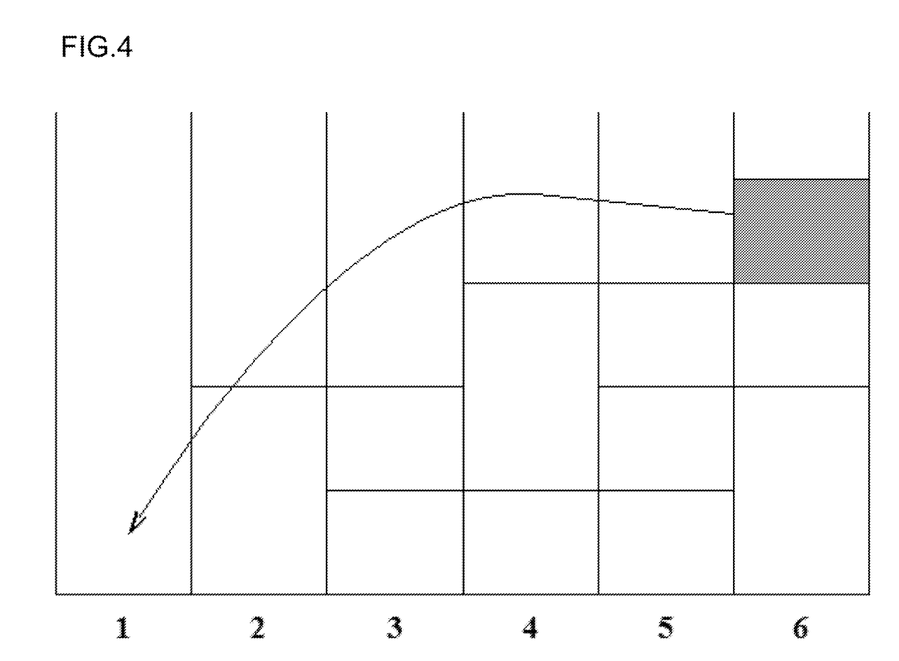

Mutation operation in standard GA is an optional operation happening with a fixed probability. Basically, mutation operation exchanges two genes in a chromosome and, in this way, leads GA to exploit virgin areas in the solution space. In this invention, a special mutation, called slide mutation, is developed. In the slide mutation, an obliged task, missing its deadline, is moved to the node with the lightest load if the moved task and the tasks in the target node all can meet their deadlines. This behavior looks like that the tasks in the heavily loaded node slide to the lightly loaded node. In each loop of GA, only one slide mutation happens, and the slide mutation is omitted if no task misses its deadlines. The mechanism of the slide mutation is shown in FIG. 4.

### <Coordination>

The lead-time of a task is usually defined to be the absolute difference of its deadline and the current time. In the coordination, the tasks in each node are sorted in the non-decreasing sequence of lead-time. Then, the sub-gene is reassigned according to the new sequence. In theory, earliest-deadline-first policy in a single node is optimal. The coordination sorts the tasks in the de facto earliest-deadline-first policy. If there is any task missing deadline after the coordination, no optimal algorithm can make it better. Thus, the GA creates various combinations of tasks in different nodes and the coordination finally adjusts the execution sequence of tasks in each node.

### <Replacement and Stop Condition>

The replacement is based on the fitness value and the unfitness value. The new individual can replace an old individual if its unfitness value is less than that of the latter. If all the unfitness values of the old individuals are 0, the old individual with the smallest fitness value will be replaced. If the new individual has the same chromosome structure with one of the old individuals in the population, the new individual is not allowed to enter the population.

The replacement can invoke the population expanding and shrinking. Before accepting a new individual, if all old individuals are feasible (all unfitness values are 0) and the population size is smaller than the number from Eq. 1, the new individual will not replace an old one and then join the population directly. If the population size is larger than the number from Eq. 1 after accepting a new individual, the most unfit individual or the individual with the largest fitness value will be deleted.

The GA will evolve the population until the stop condition is met. The stop condition is that no new individual has been generated to improve the best solution within a predefined number of generations, called evolution limit, or the number of iterations reaches the maximum generation of GA, which is also a predefined parameter, called maximum time limit. The evolution limit can stop the GA earlier than the maximum time limit. Usually the number of iterations has a near-linear relation to the execution time of GA. Hence, through setting the maximum time limit the admission time can be controlled.

### <Shrinking and Expanding Chromosomes>

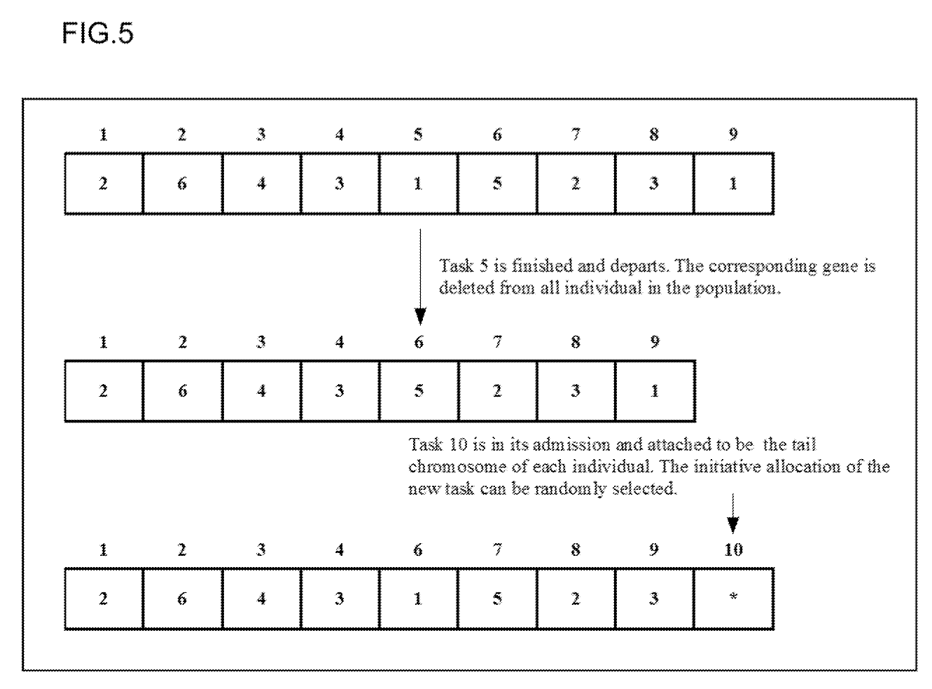

In order to facilitate the understanding of shrinking and expanding chromosomes, an instance is shown in FIG. 5. In this instance, there are 6 nodes and continuously arriving tasks. The first chromosome in FIG. 5 is assumed to be any one chromosome in a snapshot of the scheduling and admission process. After Task 5 is finished, if there is no new task arriving, the length of chromosome will shrink. Then, if a new task arrives, Task 10, and there is no old task being finished, the length of chromosome will expand. If Task 10 will not be admitted, the chromosome will roll back to the last state.

### <Dynamic Population and Chromosomes>

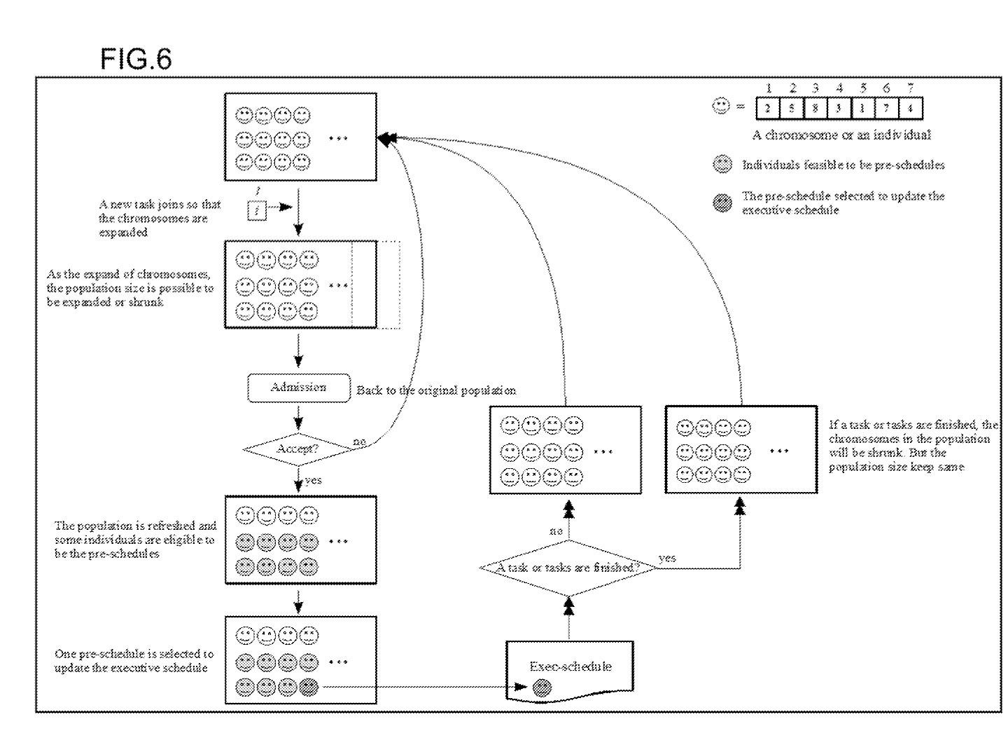

As described in the above, the chromosome length and the population size can be changed dynamically as the new task arrives and the old task departures. FIG. 6 illustrates the process clearly. A new task arrival will expand the length of chromosomes. An old task departure will shrink the length of chromosomes. In the replacement, the population size is expanded or shrunk. If the new task is admitted, the population including the chromosomes will be used continuously by the next task admission. Otherwise, the population including the chromosomes will roll back to the state before the new task arrival.

### <Admission Control and Scheduling System>

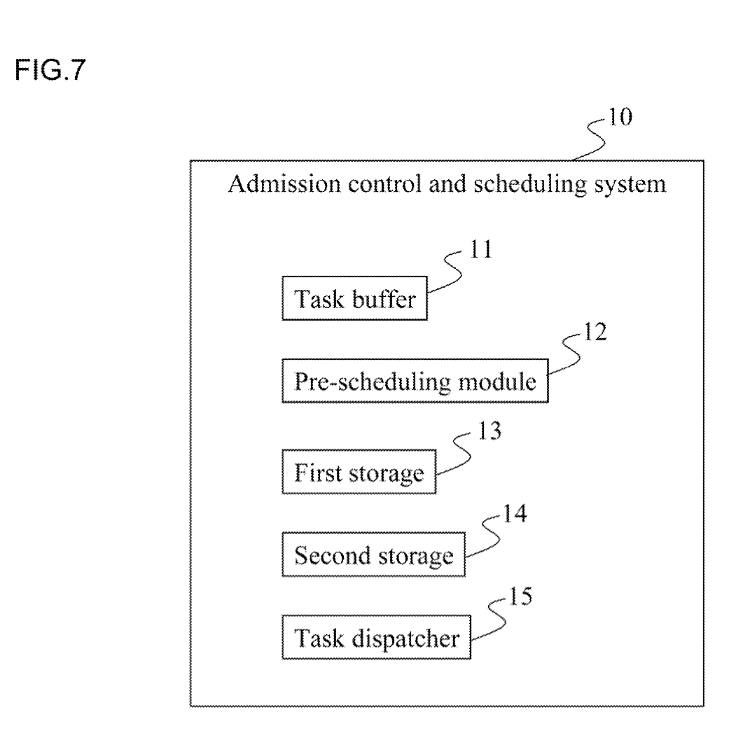

FIG. 7 is a block diagram illustrating a structure of an admission control and scheduling system according to the present invention. The admission control and scheduling system 10 includes a task buffer 11, a pre-scheduling module 12, a first storage 13, a second storage 14 and a task dispatcher 15.

The task buffer 11 buffers new arriving tasks into a waiting queue. The pre-scheduling module 12 pre-schedules a new task and a previously admitted task, produces multiple pre-schedules and uses the most feasible pre-schedule as an executive schedule. The first storage 13 stores the pre-schedules. The second storage 14 stores the executive schedule. The task dispatcher 15 dispatches the tasks in the executive schedule.

As for the program, the method and the system may be operated by a program which is programmed so as to execute the method and operate the system aforementioned. The program may be stored on any storage medium or a computer(s) and may be run in any of computer or computers making up the system.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An admission control and scheduling method of deadline constrained tasks comprising:
buffering a new arriving task into a waiting queue;
pre-scheduling the new task and a previously admitted task;
producing a plurality of pre-schedules;
selecting the most feasible pre-schedule as an executive schedule; and
dispatching the tasks in the executive schedule.

2. The method according to claim 1, wherein said pre-scheduling comprises:
duplicating the population;
expanding chromosomes in the duplicated population with the new task;
searching the optimum solution using a genetic algorithm;
accepting the new task and using the most feasible schedule to replace the executive schedule, and then, keeping the duplicated population and discarding the original population if the new task can be admitted; and
rejecting the new task and discarding the duplicated population if the new task cannot be admitted.

3. The method according to claim 2, wherein said expanding chromosomes is to attach a new gene which is the new task randomly assigned to a node.

4. The method according to claim 2, wherein the genetic algorithm comprises:
evaluating each individual and calculating a fitness value and an unfitness value;
selection;
crossover;
slide mutation;
coordination;
replacement;
updating population size; and
stop condition.

5-9. (canceled)

10. The method according to claim 4, wherein said slide mutation is to move an obliged task from a heavily loaded node to a lightly loaded node.

11-13. (canceled)

14. The method according to claim 4, wherein said updating population size is to expand and shrink the population size in a way that the population is shrunk if the population size is larger than one third of the length of chromosomes, and otherwise the population is expanded so that the replacement will not replace any individual and add the new child individual into the population directly.

15-16. (canceled)

17. An admission control and scheduling system comprising:
a task buffer that buffers a new arriving task into a waiting queue;
a pre-scheduling module that pre-schedules the new arriving task and a previously admitted task, produces a plurality of pre-schedules and uses the most feasible pre-schedule as an executive schedule;
a first storage that stores the pre-schedules;
a second storage that stores the executive schedule;
a third storage that stores an original population and its duplication; and
a task dispatcher that dispatches the tasks in the executive schedule.

18. The system according to claim 17 wherein
a task submitted by a user waits in the waiting queue and is served in the way of First Come First Serve (FCFS);
the pre-scheduling module schedules the waiting tasks one by one;
when the pre-scheduling module serves the new task, the new task and the previously admitted task are scheduled together, that is, the previously admitted task is rescheduled;
the pre-scheduling module outputs a plurality of feasible schedules, named pre-schedules;
the pre-scheduling module selects the most feasible pre-schedule according to a system requirement;
the selected pre-schedule is used as a new executive schedule; and the tasks in the executive schedule are dispatched only if there is no waiting task on the corresponding node;
a record of a task will be deleted from the executive schedule and the population after the task is dispatched; and
the executive schedule and the population are changed dynamically as a new task being admitted and an old task being dispatched.

19. The system according to claim 18 wherein the system requirement is the most balanced load.

20. A non-transitory computer-readable recording medium recorded thereon an admission control and scheduling program of deadline constrained tasks comprising:
buffering a new arriving task into a waiting queue;
pre-scheduling the new task and a previously admitted task;
producing a plurality of pre-schedules;
using the most feasible pre-schedule as an executive schedule; and
dispatching the tasks in the executive schedule.

21. The method according to claim 4, wherein the fitness value f is defined by
$$f = {\sum }_{i = 1}^{m} ( {s}_{i , j} \vert {T}_{i} ↦ {n}_{j} )$$
where s_{i,j} is a service time of a task Tᵢ in a node nⱼ and → denotes the task Tᵢ is in the node nⱼ; and
the unfitness value μ is defined by
$$μ = {\sum }_{i = 1}^{m} [ \frac{min ( 0 , {d}_{i} - {s}_{i , j} - {t}_{s} )}{{d}_{i} - {t}_{s}} \vert {T}_{i} ↦ {n}_{j} ]$$
where dᵢ is deadline of the task Tᵢ and tₛ is the time point when the new task is pre-scheduled.

22. The method according to claim 1, wherein the pre-schedules produced by pre-scheduling are feasible or infeasible;
the most feasible pre-schedule is used as the executive schedule; and
the tasks will run according to the sequence and allocation from the executive schedule.

23. The system according to claim 17, wherein, whenever the genetic pre-scheduling algorithm is to run for admitting a new task, the population is going to be duplicated a copy, i.e., there are two populations when a task is being admitted, an original population and its duplication.

24. The system according to claim 17, wherein the population and its duplication, are independent from the genetic pre-scheduling algorithm;
the genetic pre-scheduling algorithm does not create any population whenever scheduling any tasks; and
the original population is initialized with the minimal population size at the very beginning of the system, and then one population will exist in the system forever and the other one will be discarded.

25. The system according to claim 24, wherein, when a new task is admitted, the duplicated population will survive and the other one will be discarded; and
when a new task is rejected, the duplicated population will be discarded and the other one will survive.

26. The system according to claim 17, wherein the pre-schedules produced by pre-scheduling are feasible or infeasible;
the most feasible pre-schedule is used as the executive schedule; and
the tasks will run according to the sequence and allocation from the executive schedule.
